(19) United States
(12) Patent Application Publication
(10) Pub. No.: US 2019/0085460 A1
(43) Pub. Date: Mar. 21, 2019

(54) MULTILAYER COMPOSITIONS

(71) Applicant: Solvay Specialty Polymers USA, LLC, Apharetta, GA (US)

(72) Inventors: Marco APOSTOLO, Senago (IT); Gregory HARKNESS, Milton, GA (US); Stefano MAURI, Giussano (IT); Andrea Vittorio ORIANI, Bresso (IT)

(73) Assignee: Solvay Specialty Polymers USA, LLC, Alpharetta, GA (US)

(21) Appl. No.: 16/084,901

(22) PCT Filed: Mar. 9, 2017
(86) PCT No.: PCT/EP2017/055511

§ 371 Date: Sep. 13, 2018

Related U.S. Application Data
(60) Provisional application No. 62/309,749, filed on Mar. 17, 2016.

(30) Foreign Application Priority Data
Jul. 14, 2016 (EP) 16179438.3

(51) Int. Cl. C23C 18/20; C23C 18/34; B32B 15/08; B32B 27/28

(52) U.S. Cl. CPC C23C 18/208; C23C 18/34; C23C 18/30; B32B 27/286; B32B 15/08

(57) ABSTRACT

The present invention relates to a process for obtaining a multilayer composition, to a composition obtainable via such method and to an article comprising said composition. The process comprises at least the following: i. providing a polymeric layer (L1) comprising an aromatic polymer selected from the group consisting of poly(aryl ether sulfone) polymer (P1) and a polyarylene sulphide (P2), and having at least one surface (S1); ii. treating at least the surface (S1) of (L1) with a radio-frequency glow N discharge process in the presence of an etching gas medium comprising a nitrogen-containing gas to obtained an etched surface (52); iii. optionally, contacting the etched surface (S2) obtained in step ii. with a composition (LC3) comprising a surfactant to obtain at least a pre-treated surface (S2a); iv. contacting the etched surface (S2) obtained in step ii. or the pre-treated surface (S2a) obtained in step iii. with a liquid composition (LC1) comprising at least a metal (MC) in ionic form and having a pH not less than 9.0, so as to provide an article having at least one surface (S-3) treated with a composition containing metal (MC) in ionic form; v. reducing metal (MC) in ionic form on (S-3) to its metallic form by contacting (S-3) with a liquid composition (LC2) containing a reducing agent; vi. forming by electroless deposition a layer (L2) onto the at least one treated surface obtained in step v., said layer (L2) comprising at least one metal compound (M1) and metal (MC) in ionic form; vii. applying an additional layer (L3) comprising a metal (M2), equal to or different from (M1), directly on layer (L2); and, optionally, viii. applying an additional layer (L4) of a metal (M2) on (L3).

### RELATED APPLICATIONS

This application claims priority to U.S. provisional application No. 62/309749 filed Mar. 17, 2016 and to European application No. 16179438.3 filed Jul. 14, 2016, the whole content of each of these applications being incorporated herein by reference for all purposes.

### TECHNICAL FIELD

The present invention relates to a process for obtaining a multilayer composition, to a composition obtainable via such method and to an article comprising said composition.

### BACKGROUND ART

The substitution of metal with polymeric materials is advantageous in various fields of activity, including items of daily use. Using plastics in place of metal parts enables the production of wares that are generally cheaper, thinner, lighter and easier to install. In addition, plastic parts enhance design flexibility with respect to metal components and have no corrosion issues.

In the field of plumbing fixtures, until recent years brass was commonly used for the manufacturing of pipes and fixtures. However, to improve the poor workability of brass, the alloys used for plumbing articles contained a significant amount of lead, which would eventually leak into the water. The tolerable amount of lead in drinking water is extremely low (less than 11 parts per billion) because lead is a toxic element that is known to produce long-term severe effects on human health. As a substitute for lead-containing brass, plastic faucets, stop valves and tubings are available which are generally formed of acrylonitrile-butadiene-styrene (ABS) resin, that is generally plated with a metal layer on the outer surface to provide a metal appearance and tactile feeling. However, ABS plumbing fixtures may release organic compounds when in contact with hot water and do not meet the requirements of North America standard NSF/ANSI 61 and similar standards, which establish the limits for release of organic compounds in the drinking water. Hence, plated ABS materials are not approved for the manufacturing of appliances for drinkable hot water and can only be used in limited applications such as shower handles and knobs, but not in faucets, valves and similar items that may be heated to temperatures of at least 50° C.

Thus, when selecting a material for plumbing items, special attention needs to be paid to the possible leaking into the drinking water of substances from the material itself or from the outside environment, hence the material should be inert and possess excellent barrier properties also when used with hot water.

In addition, plated plumbing fixtures must meet the requirements of standards like ASME A112.18.1, which set the requirements for adhesion of the coating layers, stability in thermal cycling tests resistance to agents such as corrosion (copper-accelerated acetic acid-salt spray test—CASS).

Aromatic polymers such as polysulphones and polyphenylene sulphides are potentially suitable materials for plumbing application as metal substitutes, however difficulties have been encountered to provide a reliable and efficient method to plate their external surface with a metal layer in order to obtain metallized items that do not delaminate at high temperatures and have acceptable appearance.

GB1164845 describes a process for plating aromatic polymers which includes a first etching step using the aggressive chemical chromic acid, that is preferably avoided due to its high toxicity for the environment and for human health.

U.S. Pat. No. 4,588,623 discloses metal plated articles comprising a blend of a poly(aryl ether) polymer, a styrene and/or acrylic copolymer and a compatibilizing amount of a polyhydroxyether, that is manufactured via a process comprising etching with chromic acid.

WO00/61831 describes an item such as a faucet comprising a polymeric substrate and an outer plating metallic layer, that is deposed on the polymeric substrate by thermally spraying, which in general involves health and safety issues, is difficult to perform effectively on non-planar surfaces and provides low degree of adhesion for substrates that are small or with small curves.

The inventors found that deposition of nickel/phosphorus alloy and of copper on aromatic polymers using the conditions generally used for ABS yields poor results in terms of appearance of the final surface and of adhesion of the metal layer to the polymeric substrate.

The need is still felt for compositions comprising a polymeric material plated with a metallic layer that is suitable for applications such as the manufacturing of plumbing appliance and can be produced by a process that is safe and suitable for industrial scale.

### SUMMARY OF INVENTION

The invention provides a process for the manufacturing of a multilayer composition comprising at least the following:

i. providing a polymeric layer (L1) that comprises, or consists of, an aromatic polymer selected from the group consisting of a poly(aryl ether sulfone) polymer (P1) and a polyarylene sulphide (P2) and has at least one surface (S1);

ii. treating at least the surface (S1) of (L1) with a radio-frequency glow discharge process in the presence of an etching gas medium comprising a nitrogen-containing gas to obtained an etched surface (S2);

iii. optionally, contacting the etched surface (S2) obtained in step ii. with a composition (LC3) comprising a surfactant to obtain at least a pre-treated surface (S2a);

iv. contacting the etched surface (S2) obtained in step ii or the pre-treated surface (S2a) obtained in step iii. with a liquid composition (LC1) comprising at least a metal (MC) in ionic form and having a pH not less than 9.0, so as to provide an article having at least one surface (S-3) treated with a composition containing metal (MC) in ionic form;

v. reducing metal (MC) in ionic form on (S-3) to its metallic form by contacting (S-3) with a liquid composition (LC2) containing a reducing agent;

vi. forming by electroless deposition a layer [layer (L2)] onto the at least one treated surface obtained in step v, said layer (L2) comprising at least one metal compound [compound (M1)] and metal (MC) in ionic form;

vii. applying an additional layer (L3) comprising a metal (M2), equal to or different from (M1), directly on layer (L2); and, optionally,

viii. applying an additional layer (L4) of a metal (M2) on (L3).

In another aspect, the present invention provides a multilayer composition comprising at least the following:

a. a polymeric layer (L1) that comprises, or consists of, a poly(aryl ether sulfone) polymer (P1) or polyarylene sulphide (P2) comprising at least one surface (S1);

b. a first metallic layer (L2), which adheres directly on at least the surface (S1) and comprises nickel/phosphorus alloy and at least another metal (MC)

c. a second metallic layer (L3), which adheres directly on the surface of (L2) that is not in contact with polymeric layer (L1), comprising a metal (M2).

The present invention further provides an article comprising the multilayer composition as defined above or obtainable via the above process.

### DESCRIPTION OF EMBODIMENTS

Unless otherwise specified, in the context of the present invention the amount of a component in a composition is indicated as the ratio between the weight of the component and the total weight of the composition multiplied by 100 (also: “wt %”).

As used herein, the terms “adheres” and “adhesion” indicate that two layers are permanently attached to each other via their surfaces of contact, e.g. classified as 5B to 2B, preferably from 5B to 3B, in the cross-cut test according to ASTM D3359, test method B. For the sake of clarity, multilayer compositions wherein a polymeric layer as described above for layer (L1) and a metallic layer are assembled by contacting, e.g. by pressing (a) and (b) together, without adhesion between the two layers are outside the context of this invention.

The inventors found that the multilayer compositions wherein a polyaromatic polymer layer as defined above is at least partially plated with a metallic layer manufactured via the process of the invention are resistant to delamination also when heated at temperatures higher than 50° C., have an excellent appearance and tactile feeling, are stable over time and are particularly suitable to be used in plumbing fixtures. According to the multi-step process of the present invention, the metallic layer is applied to a surface that is pre-treated via a radio-frequency glow discharge process in the presence of an etching gas medium comprising a nitrogen-containing gas.

For the purpose of the present invention, the term “glow discharge process” is intended to denote a process powered by a radio-frequency amplifier wherein a glow discharge is generated by applying a voltage between two electrodes in a cell containing an etching gas medium. The glow discharge so generated is then typically transferred, commonly using a jet head, onto the surface of the material to be treated. Alternatively, the material to be treated is put between the electrodes in the cell containing the etching gas medium, so that the generated glow discharge is directly in contact with the surface of the material to be treated.

The glow discharge process typically comprises grafting one or more molecules onto at least a portion of the surface of the layer (L1).

For the purpose of the present invention, the term “grafting” is used, according to its usual meaning, to denote a radical process by which one or more functional groups are inserted onto the surface of a polymer backbone.

The term “functional group” is used herein according to its usual meaning to denote a group of atoms linked to each other by covalent bonds.

Without wishing to be bound by theory, inventors believe that at least a portion of the surface of the polymeric layer (L1) of the multilayer assembly obtainable via the process of the invention advantageously comprises one or more grafted functional groups.

At least a portion of the surface of the polymeric layer (L1) in the process of the invention typically comprises one or more grafted functional groups advantageously obtainable by a glow discharge process.

For the purpose of the present invention, the expression “at least a portion”, when referred to the surface comprising one or more grafted functional groups, is to be understood to mean that embodiments wherein the surface has portions on which no grafted functional group is present are still encompassed by the present invention. Nevertheless, it is generally understood that substantially the entire surface (S1) of the multilayer assembly of the invention comprises one or more grafted functional groups.

By “etching gas medium comprising nitrogen” it is hereby intended to denote either a gas or a mixture of gases suitable for use in a glow discharge process, wherein at least a portion of the gas is formed by a chemical species including at least one nitrogen atom.

The glow discharge process is typically carried out in the presence of an etching gas medium comprising at least one gas selected from the group consisting of N₂, NH₃, CH₄, CO₂, He, O₂ and H₂, and mixtures thereof.

The etching gas medium typically further comprises air.

The glow discharge process is preferably carried out in the presence of an etching gas medium comprising N₂ and/or NH₃, optionally, at least one gas selected from the group consisting of H₂ and He and, optionally, air.

According to an embodiment of the invention, the etching gas medium typically comprises N2, preferably consists of:

from 5% to 95% by volume of N₂,

optionally, up to 15% by volume of H₂,

optionally, up to 95% by volume of He, and

optionally, up to 95% by volume of air.

The glow discharge process is typically carried out under reduced pressure or under atmospheric pressure. The glow discharge process is preferably carried out under atmospheric pressure at about 760 Torr.

The glow discharge process may be carried out either under air or under modified atmosphere, e.g. under an inert gas, typically exempt notably from moisture (water vapour content of less than 0.001% v/v). The glow discharge process is preferably carried out under air.

The glow discharge process is preferably carried out at a radio-frequency comprised between 1 kHz and 100 kHz. The glow discharge process is preferably carried out at a voltage comprised between 1 kV and 50 kV.

The glow discharge process typically generates a plasma discharge.

The grafted functional groups that may be formed in the process typically comprise one or more atoms of the etching gas medium. The grafted functional groups are preferably selected from the group consisting of N-containing functional groups.

Non-limiting examples of grafted functional groups obtainable by a glow discharge process using an etching gas medium comprising, preferably consisting of, N₂ and/or NH₃, optionally, at least one gas selected from the group consisting of H₂ and He and, optionally, air, include, notably, N-containing functional groups such as amide groups (—CONH₂), amine groups (—NH₂), imine groups (—CH═NH) and nitrile groups (—CN).

The nature of the grafted functional groups of at least a portion of the surface (S2a) or (S2b) of the multilayer assembly of the invention can be determined according to any suitable techniques such as, for instance, FT-IR techniques, preferably Attenuated Total Reflectance (ATR) coupled to FT-IR techniques, or X-ray induced photoelectron spectroscopy (XPS) techniques.

The inventors have found that, after treatment by a glow discharge process using an etching gas medium according to the invention, the so-treated polymeric surface advantageously maintains its bulk properties including its mechanical properties.

The inventors have also found that, after treatment by a glow discharge process using an etching gas medium, the metal layer is successfully adhered to the so-treated polymeric surface comprising or consisting of an aromatic polymer as defined above.

In a preferred embodiment of the invention, the process comprises electroless deposition of a metal (M1) via electroless plating.

For the purpose of the present invention, by “electroless plating” it is meant a process carried out typically in a plating bath and comprising at least one metal salt, wherein the metal cation of the metal salt is reduced from its oxidation state to its elemental state in the presence of suitable chemical reducing agents without the application of electrical current.

Under step (iii-a) of the process of the invention, at least a portion of the surface (S1a) or (S1b) is coated by electroless deposition using a liquid composition [composition (LC1)] comprising at least one metal salt [salt (M1)], said salt (M1) being typically a salt of a compound (M1).

The liquid composition (LC1), as well as the other liquid compositions used in the context of the present invention, generally contains water and is preferably an aqueous composition wherein more than 50%, preferably more than 90%, of the liquid medium is water.

Under step (iv) of the process of the invention, at least a portion of the surface (S2) is contacted with a liquid composition [composition (LC1)] comprising an electroless metallization catalyst that is least one metal salt of a metal (MC), wherein MC is preferably selected from platinum, palladium gold, silver, tin and their alloys. In a preferred embodiment, the salt of (MC) in composition (LC1) is a palladium (II) salt, typically PdCl2, optionally together with a tin salt.

As used herein, the term “alloy” indicates a compound comprising a stable mixture of metals or a mixture of at least one metal and at least one non-metallic element, in any suitable weight ratio. An alloy may be a solid solution of metal elements (a single phase) or a mixture of metallic phases (two or more solutions).

For the purpose of the present invention, the expression “at least a portion”, when referred to the surface of the underlying layer coated with a metal layer, is to be understood to mean that embodiments wherein the underlying layer has portions of its surface on which no metal layer is adhered to are still encompassed by the present invention. Nevertheless, it is generally understood that substantially the entire surface of the underlying layer has adhered thereto a metal layer as defined above.

The amount of metal (MC) that is present in the compositions obtainable according to the method of the present invention is not particularly limited and, as anon-limiting example, it can range from 10-20 parts per million to 0.1% based on the total weight of layer (L2). The amount of (MC) can be determined via the techniques commonly used and known to the person skilled in the art such as atomic absorption, neutron activation, spectrophotometry, X-ray fluorescence, XPS, stripping voltammetry and similar methods.

The metals (M1), (M2) and (M3), independently from each other, are typically selected from the group consisting of Cu, Ni, Fe, Cr, Mn, Co, Zn, Ag, Au, Pt, Ru, Pd, Sn, Al, alloys thereof and derivatives thereof.

Preferably, in the process according to the present invention the metal (M1) comprises copper, nickel, a nickel/phosphorous alloy, aluminium, silver, gold, and mixtures or alloys thereof.

More preferably, in the process according to the invention the metal (M1) comprises copper or a nickel/phosphorous alloy.

Generally, the phosphorus/nickel alloy in the compositions obtainable according to the process of the invention contains from 1 to 15%, preferably 2 to 10%, more preferably 5 to 8% in weight based on the total weight of the composition of phosphorus.

Preferably, the process according to the invention comprises step iii, wherein the at least one etched surface (S2) obtained in step ii. is contacted with a composition (LC3) comprising a surfactant to obtain at least a pre-treated surface (S2a).

As used in the context of the present invention, the term “surfactant” indicates a chemical species that lowers the surface tension between a liquid and a solid. Typical examples of surfactants are organic compounds that are amphiphilic, meaning they contain both hydrophobic groups and hydrophilic groups, hence they contain both a water-insoluble (or oil-soluble) component and a water-soluble component. Preferred surfactants in the process of the invention are those of general formula (S)

NH₂-(R_{surf})-OH, (S)

wherein (R_{surf}) is a C₂-C₂₀ alkyl chain, linear, cyclic or branched, more preferably wherein (R_{surf}) is a a C₂-C₈ alkyl chain. More preferably, the surfactant in (LC3) is ethanolamine.

(LC3) contains generally water and can contain water-miscible organic solvents such as acetone or alcohols, preferably ethanol, methanol or isopropyl alcohol, most preferably isopropyl alcohol.

In a preferred embodiment, (M1) is copper and the process comprises step iii. It was found that an improved adhesion of copper to the polymeric substrate (L1) is obtained when the surface is treated with solution (LC3) prior to electroless deposition.

The composition (LC2) typically is water-based and can comprise at least one organic solvent [solvent (S)] and at least one reducing agent [agent (R)].

The solvent (S) is typically selected from the group consisting of:

aliphatic, cycloaliphatic or aromatic ether oxides, more particularly, diethyl oxide, dipropyl oxide, diisopropyl oxide, dibutyl oxide, methylter-butylether, dipentyl oxide, diisopentyl oxide, ethylene glycol dimethyl ether, ethylene glycol diethyl ether, ethylene glycol dibutyl ether benzyl oxide; dioxane, tetrahydrofuran (THF),

glycol ethers such as ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether,

glycol ether esters such as ethylene glycol methyl ether acetate, ethylene glycol monoethyl ether acetate, ethylene glycol monobutyl ether acetate,

alcohols such as methyl alcohol, ethyl alcohol, diacetone alcohol,

ketones such as acetone, methylethylketone, methylisobutyl ketone, diisobutylketone, cyclohexanone, isophorone, and

linear or cyclic esters such as: isopropyl acetate, n-butyl acetate, methyl acetoacetate, dimethyl phthalate, g-butyrolactone.

The agent (R) is typically selected from the group consisting of sodium borohydride, formaldehyde, hydrazine and sodium hypophosphite.

The inventors found that the ingredients and the pH of composition (LC1) are of major importance for the outcome of the plating process. In fact, unsatisfactory adhesion was obtained when colloidal palladium was used instead of a palladium (II) salt in (LC1) and little or no electroless deposition of the metal layer on the polymeric layer (L1) was observed when neutral or acidic solutions containing Pd(II) salts were used instead of (LC1) as defined above.

The multilayer composition of the present invention comprises a polymeric layer (L1) which comprises an aromatic polymer selected from the group consisting of a poly(aryl ether sulfone) polymer (P1) and a polyarylene sulphide (P2), and having at least one surface (S1).

### Poly(Aryl Ether Sulfone) Polymer (PAES) (P1)

For the purpose of the present invention, a “poly(aryl ether sulfone) (PAES)” denotes any polymer of which at least 50 mol. % of the recurring units are recurring units (R_{PAES}) of formula (K), the mol. % being based on the total number of moles in the polymer:

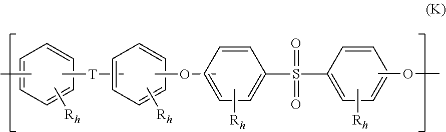

where

R, at each location, is independently selected from a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;

h, for each R, is independently zero or an integer ranging from 1 to 4; and

T is selected from the group consisting of a bond and a group —C(Rj)(Rk)—, where Rj and Rk, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium.

According to an embodiment, Rj and Rk are methyl groups.

According to an embodiment, h is zero for each R. In other words, according to this embodiment, the recurring units (R_{PAES}) are units of formula (K′):

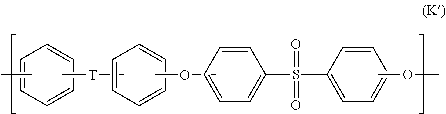

According to an embodiment of the present invention, at least 60 mol. %, at least 70 mol. %, at least 80 mol. %, at least 90 mol. %, at least 95 mol. %, at least 99 mol. % or all of the recurring units in the PAES are recurring units (R_{PAES}) of formula (K) or formula (K′).

According to an embodiment, the poly(aryl ether sulfone) (PAES) is a poly(biphenyl ether sulfone) (PPSU).

A poly(biphenyl ether sulfone) polymer is a polyarylene ether sulfone which comprises a biphenyl moiety. Poly(biphenyl ether sulfone) is also known as polyphenyl sulfone (PPSU) and for example results from the condensation of 4,4′-dihydroxybiphenyl (biphenol) and 4,4′-dichlorodiphenyl sulfone.

For the purpose of the present invention, a poly(biphenyl ether sulfone) (PPSU) denotes any polymer of which more than 50 mol. % of the recurring units are recurring units (R_{PPSU}) of formula (L):

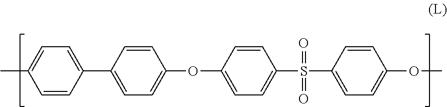

(the mol. % being based on the total number of moles in the polymer).

The PPSU polymer of the present invention can therefore be a homopolymer or a copolymer. If it is a copolymer, it can be a random, alternate or block copolymer.

According to an embodiment of the present invention, at least 60 mol. %, at least 70 mol. %, at least 80 mol. %, at least 90 mol. %, at least 95 mol. %, at least 99 mol. % or all of the recurring units in the PPSU are recurring units (R_{PPSU}) of formula (L).

When the poly(biphenyl ether sulfone) (PPSU) is a copolymer, it can be made of recurring units (R·_{PPSU}), different from recurring units (R_{PPSU}), such as recurring units of formula (M), (N) and/or (O):

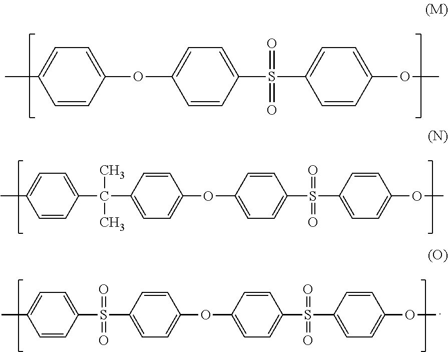

The poly(biphenyl ether sulfone) (PPSU) can also be a blend of a PPSU homopolymer and at least one PPSU copolymer as described above.

The poly(biphenyl ether sulfone) (PPSU) can be prepared by any method known in the art. It can for example result from the condensation of 4,4′-dihydroxybiphenyl (biphenol) and 4,4′-dichlorodiphenyl sulfone. The reaction of monomer units takes place through nucleophilic aromatic substitution with the elimination of one unit of hydrogen halide as leaving group. It is to be noted however that the structure of the resulting poly(biphenyl ether sulfone) does not depend on the nature of the leaving group.

PPSU is commercially available as Radel® PPSU from Solvay Specialty Polymers USA, L.L.C.

According to the present invention, the weight average molecular weight Mw of the PPSU may be from 30,000 to 80,000 g/mol, for example from 35,000 to 75,000 g/mol or from 40,000 to 70,000 g/mol.

The weight average molecular weight (Mw) of PPSU can be determined by gel permeation chromatography (GPC) using methylene chloride as a mobile phase, with polystyrene standards.

According to an embodiment, the poly(aryl ether sulfone) (PAES) is a polysulfone (PSU).

For the purpose of the present invention, a polysulfone (PSU) denotes any polymer of which more at least 50 mol. % of the recurring units are recurring units (R_{PSU}) of formula (N):

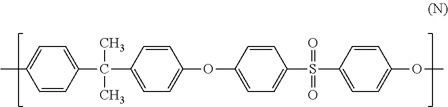

(the mol. % being based on the total number of moles in the polymer).

The PSU polymer of the present invention can therefore be a homopolymer or a copolymer. If it is a copolymer, it can be a random, alternate or block copolymer.

According to an embodiment of the present invention, at least 60 mol. %, at least 70 mol. %, at least 80 mol. %, at least 90 mol. %, at least 95 mol. %, at least 99 mol. % or all of the recurring units in the PSU are recurring units (R_{PSU}) of formula (N).

When the poly(biphenyl ether sulfone) (PSU) is a copolymer, it can be made of recurring units (R*_{PSU}), different from recurring units (R_{PSU}), such as recurring units of formula (L), (M) and/or (O) above described.

PSU is available as Udel® PSU from Solvay Specialty Polymers USA, L.L.C.

According to the present invention, the weight average molecular weight Mw of the PSU may be from 30,000 to 80,000 g/mol, for example from 35,000 to 75,000 g/mol or from 40,000 to 70,000 g/mol.

According to an embodiment, the poly(aryl ether sulfone) (PAES) is a poly(ether sulfone) (PES).

For the purpose of the present invention, a poly(ether sulfone) (PES) denotes any polymer of which more at least 50 mol. % of the recurring units are recurring units (R_{PES}) of formula (O):

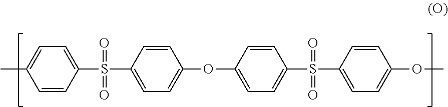

(the mol. % being based on the total number of moles in the polymer).

The PES polymer of the present invention can therefore be a homopolymer or a copolymer. If it is a copolymer, it can be a random, alternate or block copolymer.

According to an embodiment of the present invention, at least 60 mol. %, at least 70 mol. %, at least 80 mol. %, at least 90 mol. %, at least 95 mol. %, at least 99 mol. % or all of the recurring units in the PES are recurring units (R_{PES}) of formula (O).

When the poly(ether sulfone) (PES) is a copolymer, it can be made of recurring units (R*_{PES}), different from recurring units (R_{PES}), such as recurring units of formula (L), (M) and/or (N) above described.

PES is available as Veradel® PESU from Solvay Specialty Polymers USA, L.L.C.

The weight average molecular weight (Mw) of PAES, for example PPSU,

PES and PSU, can be determined by gel permeation chromatography (GPC) using methylene chloride as a mobile phase (2× 5μ mixed D columns with guard column from Agilent Technologies; flow rate: 1.5 mL/min; injection volume: 20 μL of a 0.2 w/v % sample solution), with polystyrene standards.

More precisely, the weight average molecular weight (Mw) can be measured by gel permeation chromatography (GPC), using methylene chloride as the mobile phase. In the experimental part, the following method was used: two 5μ mixed D columns with guard column from Agilent Technologies were used for separation. An ultraviolet detector of 254 nm was used to obtain the chromatogram. A flow rate of 1.5 ml/min and injection volume of 20 μL of a 0.2 w/v % solution in mobile phase was selected. Calibration was performed with 12 narrow molecular weight polystyrene standards (Peak molecular weight range: 371,000 to 580 g/mol). The weight average molecular weight (Mw) was reported.

According to an embodiment, the PAES polymers have a glass transition temperature (“T_{g}”) of at least about 200° C., at least about 210° C., or at least about 220° C. The glass transition temperature can be measured using differential scanning calorimetry (“DSC”) using a ramp rate of 20° C./minute according to the ASTM D3418 standard.

According to an embodiment, the composition of the polymeric layer (L1) include no more than about 98.5 weight percent (“wt. %”) or no more than about 98 wt. % of the PAES polymer. In such embodiments, the polymer compositions comprises at least about 50 wt. %, at least about 55 wt. % or at least about 60 wt. % of the PAES polymer.

In some embodiments where the polymer compositions includes a PSU polymer, the PSU polymer is present in a concentration of more than about 1 wt. %, at least 1.5 wt. % or at least 2 wt. %. In some such embodiments, the PSU polymer concentration is no more than about 40 wt. %, no more than about 35 wt. % or no more than about 30 wt. %. A person of ordinary skill in the art will recognize additional PSU concentration ranges within the explicitly disclosed ranges are contemplated and within the scope of the present disclosure. In some embodiments in which the polymer composition comprises a both the PSU polymer and the PPSU polymer, the total concentration of PSU and PPSU polymer can be more than about 1 wt. %. In such embodiments, the total concentration of the PSU and PPSU polymer is no more than about 40 wt. %, no more than about 35 wt. % or no more than about 30 wt. %.

According to an embodiment, the PPSU polymer is present in a concentration of at least 7 wt. %, at least 8 wt. %, at least 9 wt. %, or at least 10 wt. %. In some such embodiments, the PPSU polymer concentration is no more than about 40 wt. %, no more than about 35 wt. % or no more than about 30 wt. %. A person of ordinary skill in the art will recognize additional PPSU concentration ranges within the explicitly disclosed ranges are contemplated and within the scope of the present disclosure. In some embodiments, the PPSU polymer concentration is more than about 1 wt. % and the PPSU polymer concentration is no more than about 40 wt.%, no more than about 35 wt.% or no more than about 30 wt. %.

### The Polyarylenesulfide Polymer (PAS)(P2)

According to an embodiment, the polymeric layer (L1) comprises a poly(arylene sulfide) polymer (P2). For the purpose of the present invention, the term “poly(arylene sulfide) polymer” is intended to denote any polymer comprising recurring units wherein more than 50% by moles of said recurring units are recurring units (R_{PAS}) of formula (L):

—(Ar—S)—

wherein Ar denotes an aromatic moiety comprising at least one aromatic mono- or poly-nuclear cycle, such as a phenylene or a naphthylene group, which is linked by each of its two ends to two sulfur atoms forming sulfide groups via a direct C—S linkage.

In recurring units (R_{PAS}), the aromatic moiety Ar may be unsubstituted (i.e. a phenyl group) substituted by one or more substituent groups, including but not limited to halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

According to an embodiment of the present invention, at least about 60 mol. %, at least about 70 mol. %, at least about 80 mol. %, at least about 90 mol. %, at least about 95 mol. %, at least about 99 mol. % of the recurring units in the PAS are recurring units (R_{PAS}) of formula (L). The mol. % are based on the total number of moles in the PAS.

Most preferably, the polymer (PAS) contains no recurring units other than recurring units (R_{PAS}) of formula (L).

In recurring units (R_{PAS}), the aromatic moiety Ar is preferably selected from the group consisting of those of formulae (X-A) to (X-K) here below:

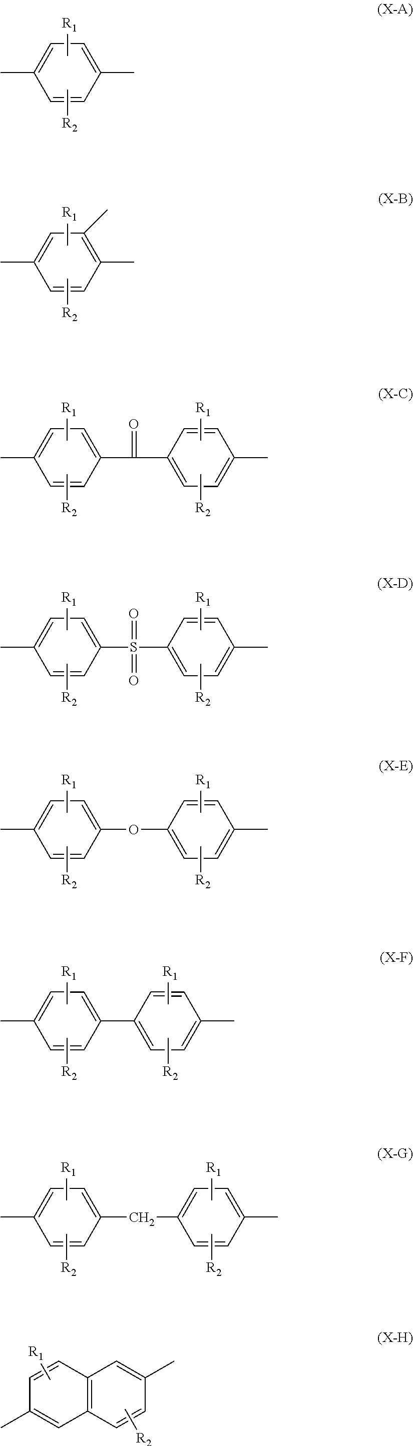

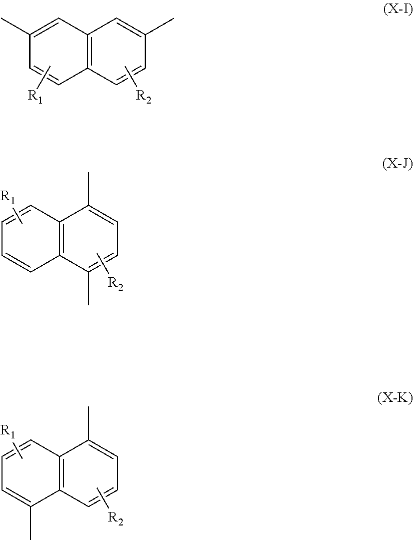

wherein R₁ and R₂, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

The polymer (PAS) may be a homopolymer or a copolymer such as a random copolymer or a block copolymer.

The polymer (PAS) can comprise one or more branched or cross-linked recurring units selected from the group consisting of those of formulae (X-L) to (X-N) here below:

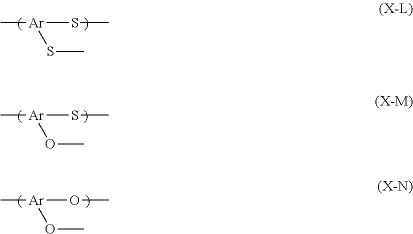

According to an embodiment of the present invention, the PAS is a polyphenylene sulfide polymer (PPS). A “polyphenylene sulfide polymer (PPS)” denotes any polymer of which at least about 50 mol. % of the recurring units are recurring units (R_{PPS}) of formula (L′) (mol. % are herein based on the total number of moles in the PPS polymer):

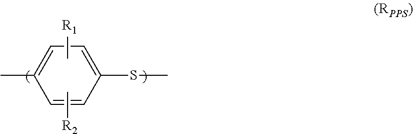

wherein R₁ and R₂, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

According to an embodiment of the present invention, at least about 60 mol. %, at least about 70 mol. %, at least about 80 mol. %, at least about 90 mol. %, at least about 95 mol. %, at least about 99 mol. % of the recurring units in the PPS are recurring units (R_{PPS}) of formula (L′). The mol. % are based on the total number of moles in the PPS.

According to an embodiment of the present invention, the polyphenylene sulfide polymer denotes any polymer of which at least 50 mol. % of the recurring units are recurring units (R_{PPS}) of formula (L′) wherein R1 and R2 are hydrogen atoms. For example, the PPS polymer is such that at least about 60 mol. %, at least about 70 mol. %, at least about 80 mol. %, at least about 90 mol. %, at least about 95 mol. %, at least about 99 mol. % of the recurring units in the PPS are recurring units (R_{PPS}) of formula (L′) wherein R₁ and R₂ are hydrogen atoms.

According to an embodiment of the present invention, the PPS polymer is such that about 100 mol. % of the recurring units are recurring units (R_{PPS}) of formula (L′):

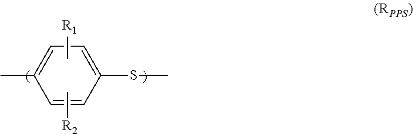

wherein R1 and R2, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains, or

wherein R₁ and R₂ are hydrogen atoms.

According to this embodiment, the PPS polymer consists essentially of recurring units (R_{PPS}) of formula (L′).

PPS is notably manufactured and sold under the trade name Ryton® PPS by Solvay Specialty Polymers USA, LLC.

According to the present invention, the weight average molecular weight of the PPS may be from 30,000 to 70,000 g/mol, for example from 35,000 to 60,000 g/mol. The weight average molecular weight can be determined by gel permeation chromatography (GPC) using ASTM D5296 with polystyrene standards.

In another embodiment of the invention, fluoropolymers were used as the layer (L1) in the process of the invention. In a preferred embodiment, polyvinylidene fluoride (PVDF) were used as the polymeric material in the layer (L1) in the process of the invention comprising steps i.-ii. and iv.-vii., and optionally viii. or i.-vii., and optionally viii., as described above.

### Additives

In some embodiments, the polymer composition of layer (L1) can include one or more additives. Additives can include, but are not limited to, fillers, heat stabilizers, plasticizers, lubricants, processing aids, impact modifiers, flame retardants and antistatic agents.

In some embodiments, the polymer composition includes a filler. Desirable fillers include, but are not limited to, glass fibers, carbon fibers, graphite fibers, silicon carbide fibers, aramide fibers, wollastonite, talc, mica, titanium dioxide, potassium titanate, silica, kaolin, chalk, alumina, boron nitride, aluminum oxide. Fillers improve possibly notably mechanical strength (e.g. flexural modulus) and/or dimensional stability and/or friction and wear resistance. For the embodiments of interest herein, the polymer composition can have a total filler concentration of from about 1 wt. % to no more than about 40 wt. %, no more than about 30 wt. %, no more than about 25 wt. %, or no more than about 20 wt. %. A person of ordinary skill in the art will recognize additional filler concentrations within the explicitly disclosed ranges are contemplated and within the scope of the present disclosure.

In some embodiments, a particularly desirable class of fillers include clay mineral fillers. Clay mineral fillers include, but are not limited to, kaolin, mica and montmorillonite. Excellent results were obtained with kaolin. In embodiments including a clay mineral filler and a PPSU polymer, the polymer compositions can have a clay mineral filler concentration of at least about 1 wt. %, at least about 5 wt. %, at least about 7 wt. %, at least about 8 wt. %, at least about 9 wt. % or at least about 10 wt. %. In such embodiments, the polymer composition can have a clay mineral filler concentration of no more than about 40, no more than about 30 wt. %, no more than about 20 wt. %, or no more than about 15 wt. %. A person of ordinary skill in the art will recognize that additional clary mineral filler concentration ranges within the explicitly disclosed ranges is contemplated and within the scope of the present disclosure.

The layer of metal (M2), and optionally that of metal (M3), can be deposed via an electroless method or via electrodeposition, according to any of the methods known to the person skilled in the art.

Thus, the process of the invention provides a cost-effective method for the production of metal-plated compositions comprising an aromatic polymer layer, that is suitable for industrial scale production.

In an aspect, the present invention provides a multilayer composition obtainable via the process as described above, preferably wherein the metal (M1) is a nickel/phosphorus alloy or copper.

Preferably, in the multilayer composition obtainable according to the process as above described, the average thickness of layer (L2) and/or of layer (L3) is from 50 nanometers to 150 micrometers, preferably from 70 nanometers to 50 micrometers, more preferably from 100 nanometers to 10 micrometers, even more preferably from 0.5 to 5 micrometers or from 1 to 3 micrometers.

The inventors found that the process of the invention provides items having at least a surface of aromatic polymer metallized with a nickel/phosphorus alloy that have superior resistance to abrasion, to delamination of the metal layer at temperatures above 50° C. and improved aesthetics with respect to electroless copper-plated items.

In an aspect, the present invention provides a multilayer composition comprising at least the following:

a. a polymeric layer (L1) that comprises, or consists of, a poly(aryl ether) polymer (P1) or polyarylene sulphide (P2) comprising at least one surface (S1);

b. a first metallic layer (L2), which adheres directly on at least the surface (S1) and comprises nickel/phosphorus alloy and from 0.001 to 10% in weight based on the total weight of (L2) of a metal (MC);

c. a second metallic layer (L3), which adheres directly on the surface of (L2) that is not in contact with polymeric layer (L1), comprising a metal (M2).

Copper electroless deposition has been described for plating the aromatic polymers surface obtained after etching. In recent times, nickel-phosphorus alloys have been established as the preferred choice for plating ABS substrates in view of several advantages. Firstly, nickel in mixture with phosphorus is cheaper and more resistant to corrosion and abrasion than copper and may provide a better adhesion and improved aesthetics in some applications. Additionally, electroless deposition solutions of copper salts tend to degrade rapidly and need to be carefully formulated, hence they are not suitable for industrial scale applications, whereas nickel-hypophosphite solutions may have a useful life in a bath over more than six months.

Generally, the phosphorus/nickel alloy in the composition of the invention contains from 1 to 15% in weight based on the total weight of the composition of phosphorus.

Preferably, in the multilayer composition according to the invention, the average thickness of layer (L2) and/or of layer (L3) is from 50 nanometers to 150 micrometers, preferably from 70 nanometers to 50 micrometers, more preferably from 100 nanometers to 10 micrometers, even more preferably from 0.5 to 5 micrometers or from 1 to 3 micrometers.

In a preferred embodiment, in the multilayer composition according to the invention the polymer of layer (L1) is a polyarylene sulphide (P2), more preferably a polyphenylene sulphide (PPS) as defined above.

Preferably, the multilayer composition according to the invention comprises at least one metallic layer deposed on the surface of the surface of layer (iii.) that is opposite to layer (ii.).

The present invention provides an article comprising the multilayer composition as described above.

Preferably, the article according to the invention is in the form of a plumbing fixture such as a faucet, a stop valve and related pieces of equipment such as ball valves, fittings, pumps, zone valves, manifolds, handles, tubing for heating and for plumbing.

It was found that the plumbing fixture according to the present invention meet the requirements of ASME A112.18.1 and NSF/ANSI 61, hence they are suitable for use with drinking water at all temperatures.

In another embodiment, the present invention provides a method for directing a stream of water wherein the means for directing water comprise, or consist of, a composition as described above. Preferably, in the method of the invention the water is drinking water. The temperature of the water that is directed according to the method of the invention is not particularly limited and can range from 5° C. to 90° C. Preferably, in the methods of the invention the means for directing water that comprise, or consist of, the composition as described above are in the form of a pipe, of a stop valve, of a faucet, or of a circuit that comprises all or at least a part of said elements. Without limitation, the circuit can be in the form of a household plumbing system.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### Raw Materials

Polymeric substrate: UDEL® PSU P 1700 NT (polymer P1) supplied by Solvay Specialty Polymers USA L.L.C.

### Example 1—Manufacture of a Sample

### Step 1-A—Surface Modification

Whole surface of (P1) sample was treated at atmospheric pressure by a radio-frequency plasma discharge process. (Plasmatreater® AS400) in the following conditions: the etching gas was N2, the working frequency was 20 kHz and the voltage was 0.3 kV.

Step 1-B—Surface Cleaning

The treated surface of the (P1) sample obtained according to Step 1-A was immersed in an aqueous solution containing Ethanolamine (20% w/w) and Isopropyl alcohol (1% w/w) for 3 minutes.

### Step 1-C—Metallization Process after Cleaning

The treated surface of the (P1) sample obtained according to Step 1-B was coated with metallic nickel by electroless plating. Prior to nickel deposition, the treated surface was activated by immersion in an aqueous solution containing 0.03 g/L of PdCl₂ for 1 minute (pH=9.5), resulting in the treated surface of the (P1) sample being entirely coated with Pd particles at a high density. The so activated surface of the sample was then immersed in an aqueous plating bath containing 25 g/L of NiSO₄, 6 g/L of sodium borohydride, 15 g/L of malic acid and organic additives. The plating temperature was 40° C. and its pH value was 9. The thickness of the nickel layer coated onto the treated surface of the Udel surface was 0.15 μm as measured by SEM.

### Comparative Example 2—Manufacture of a Sample with Activation Step according to the procedure developed for ABS polymeric materials (colloidal palladium).

An Udel® sample was treated following step 1-A of example 1 and as covered with metallic nickel by electroless plating. Prior to nickel deposition, the treated surface was activated by immersion in an aqueous solution containing 80 mg/L of colloidal palladium and 100 ml/L HCl for 4 minutes, resulting in the treated surface of the Udel® sample being entirely coated with Pd particles at a high density deriving from colloidal palladium. The so activated surface of the Udel® sample was then immersed in an aqueous plating bath containing 90 g/L of NiSO4, boric acid and organic additives. The plating temperature was 40° C. and its pH value was 9. Nickel coating thus obtained was found to be partially detached immediately after deposition process.

### Example 3—Manufacture of a Sample without Surface Cleaning Step

A Udel® sample was treated following step 1-A and 1-C without surface cleaning with solution (LC1) according to the invention (step 1-B) in order to evaluate how surface cleaning influences adhesion behaviour.

Adhesion measured on this sample was significantly lower in respect of sample obtained according to Example 1 that comprises the treatment with composition (LC1).

### Example 4—Chromium Finishing of Nickel Plated Sample

Sample obtained according to Example 1 was coated with metallic chromium by electrodeposition plating. Prior to chromium deposition, the sample was coated with copper and nickel in order to increase metallic thickness and to minimize internal stresses.

### Tests Description

### Measurement of Adhesion Strength

The adhesion strength between the metallic layer (Mc) and the layer (Pc) of the tube of the multilayer tubular articles of the invention was measured according to ASTM D3359 standard procedure. Using a cutting tool, two series of perpendicular cuts were performed on the metallic layer of the tapes obtained according to either Example 1 or Example 2 thereby providing a lattice pattern thereon. A piece of an adhesive label was then applied over the lattice and removed with an angle of 180° with respect to the metallic layer.

The classification of test results ranged from 5B to 0B, whose descriptions are depicted in Table 1 here below:

TABLE 1

| ASTM | |
|---|---|
| D3359 | |
| Classification | Description |
| 5B | The edges of the cuts are completely smooth; none of |
| | the squares of the lattice is detached. |
| 4B | Detachment of flakes of the coating at the intersections |
| | of the cuts. A cross cut area not significantly greater |
| | than 5% is affected. |
| 3B | The coating has flaked along the edges and/or at the |
| | intersection of the cuts. A cross cut area significantly |
| | greater than 5%, but not significantly greater than 15% |
| | is affected. |
| 2B | The coating has flaked along the edges of the cuts partly |
| | or wholly in large ribbons, and/or it has flaked partly of |
| | wholly on different parts of the squares. A cross cut |
| | area significantly greater than 15%, but not significantly |
| | greater than 65%, is affected. |
| 1B | The coating has flaked along the edges of the cuts in |
| | large ribbons and/or some squares have detached partly |
| | or wholly. A cross cut area significantly greater than |
| | 35%, but not significantly greater than 65%, is affected. |
| 0B | Any degree of flaking that cannot be classified even by |
| | classification 1B. |

Table 2 summarizes the results of the adhesion tests:

TABLE 2

| Run | Adhesion strength |
|---|---|
| Ex. 1 | 5B |
| Ex. 3 | 2B |
| C. Ex. 2 | 0B |

1-15. (canceled)

16. A process for making a multilayer composition comprising:
treating at least a surface (S1) of a polymeric layer (L1) with a radio-frequency glow discharge process in the presence of an etching gas medium comprising a nitrogen-containing gas to obtain an etched surface (S2), wherein the polymeric layer (L1) comprises an aromatic polymer selected from the group consisting of a poly(aryl ether sulfone) polymer (P1) and a polyarylene sulphide (P2);
optionally, contacting the etched surface (S2) with a composition (LC3) comprising a surfactant to obtain at least a pre-treated surface (S2a);
obtaining an article having at least one surface (S-3) treated with a composition containing metal (MC) in ionic form by contacting the etched surface (S2) or the pre-treated surface (S2a) with a liquid composition (LC1) comprising at least one metal (MC) in ionic form and having a pH not less than 9.0;
reducing the metal (MC) in ionic form on the surface (S-3) to its metallic form by contacting the surface (S-3) with a liquid composition (LC2) comprising a reducing agent;
forming by electrolysis a deposition layer (L2) onto the at least one treated surface obtained by reducing the metal (MC) in ionic form on the surface (S-3), wherein the deposition layer (L2) comprises at least one metal compound (M1) and the metal (MC) in ionic form;
applying to the deposition layer (L2) an additional layer (L3), wherein the additional layer (L3) comprises a metal (M2), wherein the metal (M2) is equal to or different from the metal compound (M1); and
optionally, applying an additional layer (L4) of the metal (M2) to the additional layer (L3).

17. The process according to claim 16, wherein treating the surface (S1) of the polymeric layer (L1) with the radio-frequency glow discharge process is carried out at a radio-frequency comprised between 1 kHz and 100 kHz, at a voltage comprised between 1 kV and 50 kV, or a combination thereof.

18. The process according to claim 16, wherein the etching gas medium is selected from the group consisting of air, N₂, NH₃, and mixtures thereof.

19. The process according to claim 16, wherein the metal compound (M1) is selected from copper, nickel, a nickel/phosphorous alloy, aluminium, and mixtures or alloys thereof.

20. The process according to claim 16, wherein the metal compound (M1) is copper, and the process comprises contacting the etched surface (S2) with the composition (LC3) comprising the surfactant to obtain the pre-treated surface (S2a).

21. A multilayer composition comprising:
a polymeric layer (L1) comprising an aromatic polymer selected from the group consisting of a poly(aryl ether sulfone) polymer (P1) and a polyarylene sulphide (P2), wherein the polymeric layer (L1) has at least one surface (S1);
a first metallic layer (L2) adhered directly on the surface (S1), wherein the first metallic layer (L2) comprises at least one nickel/phosphorus alloy and at least one other metal (MC); and
a second metallic layer (L3) adhered directly on the surface of the first metallic layer (L2) comprising a metal (M2), with the proviso that the second metallic layer (L3) is not in contact with the polymeric layer (L1).

22. The multilayer composition according to claim 21, wherein the average thickness of the first metallic layer (L2) and second metallic layer (L3) is from 50 nanometers to 150 micrometers.

23. The multilayer composition according to claim 21, wherein the metal (M2) is selected from Cu, Ni, Fe, Cr, Mn, Co, Zn, Ag, Au, Pt, Ru, Pd, Sn, Al, and alloys thereof and derivatives thereof.

24. The multilayer composition according to claim 21, wherein the polymeric layer (L1) comprises at least one poly(aryl ether sulfone) polymer (P1), in which at least 50 mol. % of the recurring units are recurring units (R_{PAES}) of formula (I): 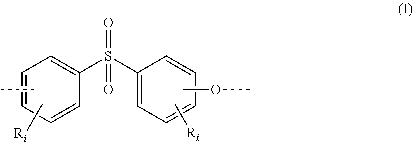
based on the total number of moles in the polymer,
where each R₁, equal to or different from each other, is selected from a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium, and each i, equal to or different from each other, is an integer ranging from 0 to 4.

25. The multilayer composition according to claim 24, wherein the poly(aryl ether sulfone) polymer (P1) comprises at least 50 mol. % of recurring units selected from:

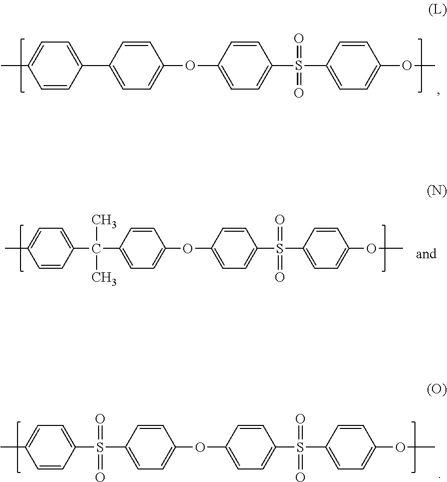

26. The multilayer composition according to claim 25, wherein the poly(aryl ether sulfone) polymer (P1) comprises at least 50 mol. % of recurring units of formula (N).

27. The multilayer composition according to claim 21 further comprising at least one metallic layer on the surface of the second metallic layer (L3), wherein the at least one metallic layer is opposite to the first metallic layer (L2).

28. A multilayer composition obtained by the process of claim 16.

29. An article comprising the multilayer composition according to claim 21, wherein the article is selected from plumbing fixtures, stop valves, ball valves, fittings, pumps, zone valves, manifolds, handles, and tubes.

30. A method for directing a stream of water, wherein the method comprises the multilayer composition according to claim 21.

31. The process according to claim 16, wherein the metal compound (M1) is at least one nickel/phosphorus alloy.
